(19) United States
(12) Patent Application Publication
(10) Pub. No.: US 2023/0113364 A1
(43) Pub. Date: Apr. 13, 2023

(54) ALL SOLID STATE BATTERY

(71) Applicant: TOYOTA JIDOSHA KABUSHIKI KAISHA, Toyota-shi (JP)

(72) Inventor: Ippei GOTO, Okazaki-shi (JP)

(73) Assignee: TOYOTA JIDOSHA KABUSHIKI KAISHA, Toyota-shi (JP)

(21) Appl. No.: 17/945,609

(22) Filed: Sep. 15, 2022

(30) Foreign Application Priority Data
Sep. 27, 2021 (JP) 2021-156540

(51) Int. Cl. H01M 10/0585; H01M 10/0562; D06M 23/10; D06M 11/13; D06M 11/52; D06M 15/693

(52) U.S. Cl. CPC H01M 10/0585; D06M 11/13; D06M 11/52; D06M 15/693; D06M 23/10; H01M 10/0562; D06M 2101/32; H01M 2300/0068

(57) ABSTRACT

An all solid state battery includes an electrode structure body including a cathode layer, an anode layer, and a solid electrolyte layer arranged between the cathode layer and the anode layer, wherein: the electrode structure body includes a facing part where the cathode layer and the anode layer face to each other; in a plan view along a thickness direction, a shape of the facing part is a rectangular shape including a longer side and a shorter side; a rate of a length of the longer side with respect to a length of the shorter side is 1.5 or more; the solid electrolyte layer contains a nonwoven fabric, and a solid electrolyte arranged inside the nonwoven fabric; and in the plan view, an angle formed by a longer direction in the facing part and a fabric direction in the nonwoven fabric is 0° or more and 30° or less.

### TECHNICAL FIELD

The present disclosure relates to an all solid state battery.

### BACKGROUND ART

An all solid state battery is a battery including a solid electrolyte layer between a cathode layer and an anode layer, and one of the advantages thereof is that the simplification of a safety device may be more easily achieved compared to a liquid-based battery including a liquid electrolyte containing a flammable organic solvent. Patent Literature 1 discloses a solid electrolyte sheet to be used for an all solid secondary battery, the solid electrolyte sheet comprising a nonwoven fabric, and a solid electrolyte on a surface of and inside the nonwoven fabric.

Patent Literature 2 discloses a method for producing a solid electrolyte film for an all solid state battery comprising a step of forming a nonwoven fabric including fiber formed of a resin. Also, Patent Literature 3 discloses an electrode assembly comprising a first electrode including a first structure body formed by a plurality of fibers extending to a first direction, a second electrode including a second structure body formed by a plurality of fibers extending to a second direction that is different from the first direction, and a separation film arranged between the first structure body and the second structure body.

### Citation List

### Patent Literatures

Patent Literature 1: Japanese Patent Application Laid-Open (JP-A) No. 2016-031789

Patent Literature 2: JP-A No. 2020-181758

Patent Literature 3: Japanese Unexamined Patent Publication (JP-A) No. 2013-534704

### SUMMARY OF DISCLOSURE

### Technical Problem

From a viewpoint of improving performance of a battery, an all solid state battery with excellent cycle characteristics has been required. The present disclosure has been made in view of the above circumstances and a main object thereof is to provide an all solid state battery with excellent cycle characteristics.

### Solution to Problem

The present disclosure provides an all solid state battery comprising an electrode structure body including a cathode layer, an anode layer, and a solid electrolyte layer arranged between the cathode layer and the anode layer, wherein: the electrode structure body includes a facing part where the cathode layer and the anode layer face to each other; in a plan view along a thickness direction, a shape of the facing part is a rectangular shape including a longer side and a shorter side; a rate of a length of the longer side with respect to a length of the shorter side is 1.5 or more; the solid electrolyte layer contains a nonwoven fabric, and a solid electrolyte arranged inside the nonwoven fabric; and in the plan view, an angle formed by a longer direction in the facing part and a fabric direction in the nonwoven fabric is 0° or more and 30° or less.

According to the present disclosure, the angle formed by the longer direction in the facing part and the fabric direction in the nonwoven fabric is in the specified range, and thus the all solid state battery with excellent cycle characteristics may be obtained.

In the disclosure, the angle may be 0° or more and 10° or less.

In the disclosure, a void rate in the nonwoven fabric may be 70% or more and 90% or less.

In the disclosure, in the nonwoven fabric, a tensile strength of the fabric direction may be larger than a tensile strength of a direction orthogonal to the fabric direction.

In the disclosure, the solid electrolyte may be an inorganic solid electrolyte.

In the disclosure, the inorganic solid electrolyte may be at least one kind of a sulfide solid electrolyte, an oxide solid electrolyte, and a hydride solid electrolyte.

In the disclosure, the solid electrolyte may be a molten salt, which is in a solid state at 25° C.

In the disclosure, the solid electrolyte may be a plastic crystal solid electrolyte.

### Advantageous Effects of Disclosure

The all solid state battery in the present disclosure exhibits an effect of excellent cycle characteristics.

### BRIEF DESCRIPTION OF DRAWINGS

FIG. 1 is a schematic cross-sectional view exemplifying the all solid state battery in the present disclosure.

FIG. 2 is a schematic perspective view explaining the electrode structure body in the present disclosure.

### DESCRIPTION OF EMBODIMENTS

The all solid state battery in the present disclosure is hereinafter explained in details with reference to drawings. Each drawing described as below is a schematic view, and the size and the shape are appropriately exaggerated in order to be understood easily. Further, in each drawing, hatchings or reference signs are appropriately omitted.

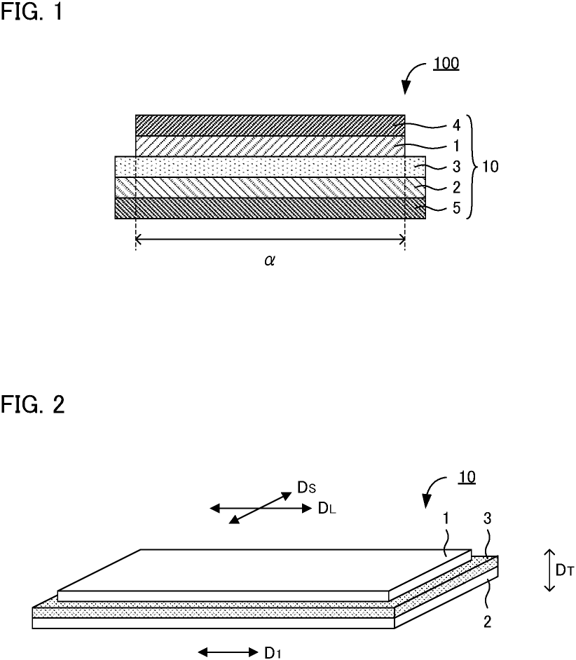

FIG. 1 is a schematic cross-sectional view exemplifying the all solid state battery in the present disclosure. All solid state battery 100 illustrated in FIG. 1 comprises electrode structure body 10 including cathode layer 1, anode layer 2, solid electrolyte layer 3 arranged between the cathode layer 1 and the anode layer 2, cathode current collector 4 for collecting currents of the cathode layer 1, and anode current collector 5 for collecting currents of the anode layer 2. Incidentally, although not particularly illustrated, the all solid state battery 100 may include an outer package and a restraining part as described later. The electrode structure body 10 includes facing part α where the cathode layer 1 and the anode layer 2 face to each other.

FIG. 2 is a schematic perspective view explaining the electrode structure body in the present disclosure. Electrode structure body 10 illustrated in FIG. 2 includes cathode layer 1, anode layer 2, and solid electrolyte layer 3 arranged between the cathode layer 1 and the anode layer 2. In the electrode structure body 10 illustrated in FIG. 2, the shapes of the anode layer 2 and the solid electrolyte layer 3 in a plan view are the same. Further, in a plan view along thickness direction D_{T}, the outer peripheries of the anode layer 2 and the solid electrolyte layer 3 are positioned in outer side compared to the outer periphery of the cathode layer 1. In other words, the areas of the anode layer 2 and the solid electrolyte layer 3 are respectively larger than the area of the cathode layer 1. For this reason, the shape of the facing part in a plan view matches the shape of the cathode layer 1 in a plan view, which is a rectangular shape including a longer side and a shorter side.

Also, as shown in FIG. 2, in the present disclosure, the direction to which the longer side of the facing part extends is defined as the longer direction D_{L} of the facing part, and the direction orthogonal to the longer direction D_{L} is defined as the shorter direction Dₛ of the facing part. Meanwhile, the solid electrolyte layer 3 contains a nonwoven fabric, and a solid electrolyte arranged inside the nonwoven fabric. In a plan view along the thickness direction D_{T}, the angle formed by the longer direction D_{L} of the facing part and the fabric direction D₁ in the nonwoven fabric included in the solid electrolyte layer 3 is in the specified range. Incidentally, the angle formed by the D_{L} and the D₁ signifies an acute angle side.

According to the present disclosure, the angle formed by the longer direction in the facing part and the fabric direction in the nonwoven fabric is in the specified range, and thus the all solid state battery with excellent cycle characteristics may be obtained. As described in the above described Patent Literature 1, a solid electrolyte sheet (solid electrolyte layer) including a solid electrolyte inside a nonwoven fabric has been known. When the solid electrolyte layer includes a nonwoven fabric, for example, there is an advantage that the thickness of the solid electrolyte layer may be decreased while maintaining the insulation properties.

Meanwhile, when a plurality of fibers configuring the nonwoven fabric extend to one direction, the tensile strength thereof is not isotropic, but is anisotropic. Here, the direction to which the plurality of fibers mainly extend is defined as a fabric direction. The fabric direction usually matches Machine Direction (MD), which corresponds to a running direction (flow direction) in a production process of the nonwoven fabric. Also, in general, the direction orthogonal to the MD is referred to as Cross Direction (CD). The MD and the CD may be specified by observing the nonwoven fabric with a microscope, and confirming the direction to which the fabric extends. When the plurality of fibers configuring the nonwoven fabric extend to one direction, a tensile strength of the fabric direction (MD) is usually larger than a tensile strength of the direction (CD) orthogonal to the fabric direction.

In the nonwoven fabric, when the tensile strength of the MD and the tensile strength of the CD are different, uniformity of the solid electrolyte layer would be deteriorated every when stress along charge and discharge is applied to the solid electrolyte layer. As a result, internal short circuit such as slight short circuit easily occurs to degrade cycle characteristics. Also, when the shape of the facing part in a plan view is a rectangular shape including a longer side and a shorter side, the volume change (such as volume changed due to elongation) in the longer direction easily occurs. In contrast, in the present disclosure, the solid electrolyte layer is arranged so that the longer direction, of which volume change easily occurs, matches the fabric direction (MD), of which tensile strength is large. Thereby, the anisotropy of the tensile strength may be moderated. As a result, the uniformity of the solid electrolyte layer is maintained to improve cycle characteristics.

As shown in FIG. 2, D_{L} designates the longer direction in the facing part. Similarly, D₁ designates a fabric direction in the nonwoven fabric included in the solid electrolyte layer 3. The angle formed by the D_{L} and the D₁ is usually 30° or less, may be 20° or less, and may be 10° or less. Meanwhile, the angle formed by the D_{L} and the D₁ may be 0° and may be larger than 0°.

### 1. Electrode Structure Body

An electrode structure body in the present disclosure includes a cathode layer, an anode layer, and a solid electrolyte layer arranged between the cathode layer and the anode layer. Also, the electrode structure body includes a facing part where the cathode layer and the anode layer face to each other. In a plan view along a thickness direction, a shape of the facing part is a rectangular shape including a longer side and a shorter side. The shape of the facing part in a plan view is typically a rectangular shape. Also, the rate of the length of the longer side with respect to the length of the shorter side is, usually 1.5 or more, may be 2.0 or more, and may be 2.5 or more. Meanwhile, the rate of the length of the longer side with respect to the length of the shorter side is, for example, 20 or less and may be 15 or less.

### Solid Electrolyte Layer

The solid electrolyte layer in the present disclosure is a layer arranged between the cathode layer and the anode layer. The solid electrolyte layer contains a nonwoven fabric, and a solid electrolyte arranged inside the nonwoven fabric.

### (i) Nonwoven Fabric

The nonwoven fabric usually includes a plurality of fibers, and voids are formed among the plurality of fibers. Also, the plurality of fibers extend along the fiber direction. The plurality of fibers may extend, along the fiber direction, linearly, meanderingly, or zigzaggingly. Examples of the material for the fibers may include a resin such as a polyester-based resin, a polyolefin-based resin, and a polyamide-based resin. Examples of the polyester-based resin may include polyethylene terephthalate (PET). Examples of the polyolefin-based resin may include polyethylene (PE), and a polypropylene (PP). Examples of the polyamide-based resin may include nylon and aramid. Also, glass may be used as the material for the fibers. In other words, the nonwoven fabric may be glass fabric nonwoven fabric. There are no particular limitations on the fiber diameter and the fiber length of the fibers configuring the nonwoven fabric.

The void rate of the nonwoven fabric is not particularly limited, and for example, it is 50% or more, may be 60% or more, and may be 70% or more. If the void rate of the nonwoven fabric is too little, internal resistance would easily increase. Meanwhile, the void rate of the nonwoven fabric is, for example, 95% or less and may be 90% or less. If the void rate of the nonwoven fabric is too much, there is a possibility that it may not work as a supporting body. The void rate of first nonwoven fabric may be obtained by, for example, observing the cross-section of the nonwoven fabric. Also, there are no particular limitations on the size of the void.

In the nonwoven fabric, TS₁ designates the tensile strength of the fabric direction (MD), and TS₂ designates the tensile strength of the direction (CD) orthogonal to the fabric direction. The TS₁ is preferably larger than the TS₂. In this case, cycle characteristics tend to degrade due to the anisotropy of the tensile strength. In contrast, in the present disclosure, by setting the angle formed by the longer direction in the facing part and the fabric direction in the nonwoven fabric in the specified range, the anisotropy of the tensile strength is moderated. The TS₁ is, for example, 1 N/cm or more, may be 3 N/cm or more, and may be 5 N/cm or more. Meanwhile, TS₁ is, for example, 50 N/cm or less. Also, the TS₂ is, for example, 0.1 N/cm or more, may be 0.5 N/cm or more, and may be 1 N/cm or more. Meanwhile, the TS₂ is, for example, 30 N/cm or less. Also, the rate of the TS₁ with respect to the TS₂, which is TS₁/TS₂ is, for example, 1.1 or more, may be 1.5 or more, may be 2.0 or more, and may be 5.0 or more. Meanwhile, the TS₁/TS₂ is, for example, 50 or less.

Examples of the kind of the nonwoven fabric may include a chemical bond nonwoven fabric, a thermal bond nonwoven fabric, an air laid nonwoven fabric, a spun lace nonwoven fabric, a spunbonded nonwoven fabric, a melt blown nonwoven fabric, a needle punched nonwoven fabric, and a stitch bond nonwoven fabric. Also, the thickness of the nonwoven fabric is not particularly limited, and for example, it is 1 µm or more, may be 5 µm or more, and may be 10 µm or more. Meanwhile, the thickness of the nonwoven fabric is, for example, 50 µm or less.

### (ii) Solid Electrolyte

The solid electrolyte layer contains a solid electrolyte arranged inside the nonwoven fabric. The solid electrolyte layer may contain just one kind of the solid electrolyte, and may contain two kinds or more thereof. Examples of the solid electrolyte may include an inorganic solid electrolyte such as a sulfide solid electrolyte, an oxide solid electrolyte, a hydride solid electrolyte, a halide solid electrolyte, and a nitride solid electrolyte. The sulfide solid electrolyte preferably contains sulfur (S) as a main component of the anion element. The oxide solid electrolyte preferably contains oxygen (O) as a main component of the anion element. The hydride solid electrolyte preferably contains hydrogen (H) as a main component of the anion element. The halide solid electrolyte preferably contains halogen (X) as a main component of the anion. The nitride solid electrolyte preferably contains nitrogen (N) as a main component of the anion element.

It is preferable that the sulfide solid electrolyte contains, for example, a Li element, an A element (A is at least one kind of P, As, Sb, Si, Ge, Sn, B, Al, Ga, and In), and a S element. Also, the sulfide solid electrolyte may further contain at least one of an O element and a halogen element. Examples of the halogen element may include a F element, a Cl element, a Br element, and an I element.

The sulfide solid electrolyte preferably includes an anion structure of an ortho composition (such as PS₄³⁻ structure, SiS₄⁴⁻ structure, GeS₄⁴⁻ structure, AlS₃³⁻ structure, or BS₃³⁻ structure) as the main component of the anion structure. The reason therefor is that chemical stability is high. The proportion of the anion structure of the ortho composition with respect to all the anion structures in the sulfide solid electrolyte is, for example, 70 mol% or more and may be 90 mol% or more.

The sulfide solid electrolyte may be amorphous, and may be crystalline. In the latter case, the sulfide solid electrolyte includes a crystal phase. Examples of the crystal phase may include a Thio-LISICON type crystal phase, a LGPS type crystal phase, and an argyrodite type crystal phase.

There are no particular limitations on the composition of the sulfide solid electrolyte, and examples thereof may include xLi₂S•(100-x)P₂S₅(70≤x≤80) , and yLiI -zLiBr·(100-y-z) (xLi₂S·(1-x) P₂S₅) (0.7≤x≤0.8, 0≤y≤30, 0≤z≤30).

The sulfide solid electrolyte may have a composition represented by a general formula (1) : Li₄₋ₓGe₁₋ₓPₓS₄ (0<x<1) . In the general formula (1), at least a part of Ge may be substituted with at least one of Sb, Si, Sn, B, Al, Ga, In, Ti, Zr, V and Nb. In the general formula (1), at least a part of P may be substituted with at least one of Sb, Si, Sn, B, Al, Ga, In, Ti, Zr, V and Nb. In the general formula (1), a part of Li may be substituted with at least one of Na, K, Mg, Ca and Zn. In the general formula (1), a part of S may be substituted with halogen (at least one of F, Cl, Br and I).

Additional examples of the composition of the sulfide solid electrolyte may include Li_{7-x-2y}PS_{6-x-y}X_{y}, Li_{8-x-2y}SiS_{6-x-y}X_{y}, and Li_{8-x-2yG}eS_{6-x-y}X_{y}. In these compositions, X is at least one kind of F, Cl, Br and I, and x and y satisfy 0 ≤ x, 0 ≤ y·

Examples of the oxide solid electrolyte may include a solid electrolyte containing a Li element, a Y element (Y is at least one kind of Nb, B, Al, Si, P, Ti, Zr, Mo, W, and S) , and an O element. Specific examples of the oxide solid electrolyte may include a garnet type solid electrolyte such as Li₇La₃Zr₂O₁₂, Li₇₋ₓLa₃(Zr₂₋ₓNbₓ)O₁₂ (0≤x≤2) , and Li₅La₃Nb₂O₁₂; a Perovskite type solid electrolyte such as (Li, La) TiO₃, (Li,La) NbO₃, and (Li, Sr) (Ta, Zr) O₃; a nasicon type solid electrolyte such as Li (Al,Ti) (PO₄)₃, and Li(Al,Ga) (PO₄)₃; a Li-P-O-based solid electrolyte such as Li₃PO₄, and LIPON (a compound formed by substituting a part of O in Li₃PO₄ with N); and a Li-B-O-based solid electrolyte such as Li₃BO₃, and a compound formed by substituting a part of O in Li₃BO₃ with C.

The hydride solid electrolyte includes, for example, Li, and a complex anion containing hydrogen. Examples of the complex anon may include (BH₄)⁻, (NH₂)⁻, (A1H₄)⁻, and (AlHₑ)³⁻. Examples of the halide solid electrolyte may include Li_{6-3z}Y_{z}X₆ (X is at least one kind of Cl and Br, and z satisfies 0 < z < 2). Examples of the nitride solid electrolyte may include Li₃N.

Additional examples of the solid electrolyte may include a molten salt, which is in a solid state at 25° C. The molten salt includes a cation and an anion. Examples of the cation may include an inorganic cation such as a lithium ion; and an organic cation such as an ammonium-based cation, a piperidinium-based cation, a pyrrolidinium-based cation, an imidazolium-based cation, a pyridium-based cation, an alicyclic amine-based cation, an aliphatic amine-based cation, and an aliphatic phosphonium-based cation. Examples of the anion may include an anion having a sulfonyl amide structure. Examples of the anion having the sulfonyl amide structure may include
bis(trifluoromethanesulfonyl)amide,
bis(fluorosulfonyl)amide,
bis(pentafluoroethanesulfonyl)amide, and
(fluorosulfonyl)(trifluoromethanesulfonyl)amide. The melting point of the molten salt is, usually 25° C. or more, may be 30° C. or more, and may be 40° C. or more. Meanwhile, the melting point of the molten salt is, for example, 200° C. or less, may be 150° C. or less, and may be 120° C. or less.

Additional examples of the solid electrolyte may include a plastic crystal solid electrolyte. The plastic crystal refers to a material configured by a regularly organized three-dimensional crystal lattice, wherein orientational and rotational disorder is present in the level of molecular species or molecular ions. The plastic crystal includes a cation and an anion. Examples of the cation may include pyrrolidinium, tetraalkyl ammonium and tetraalkyl phosphonium. Examples of the anion may include hexafluorophosphate, tetrafluoroborate, thiocyanate, bis(trifluoromethanesulfonyl)amide,
bis(fluorosulfonyl)amide,
bis(pentafluoroethanesulfonyl)amide, and
(fluorosulfonyl)(trifluoromethanesulfonyl)amide.

Examples of the shape of the solid electrolyte may include a granular shape. The average particle size (D₅₀) of the solid electrolyte is not particularly limited, and for example, it is 10 nm or more, and may be 100 nm or more. Meanwhile, the average particle size (D₅₀) of the solid electrolyte is, for example, 50 µm or less, and may be 20 µm or less. The average particle size (D₅₀) of the solid electrolyte is preferably smaller than the thickness of the nonwoven fabric. The average particle size (D₅₀) may be calculated from, for example, a measurement with a laser diffraction particle distribution meter or a scanning electron microscope (SEM). The proportion of the total volume of the solid electrolyte with respect to the total volume of the void in the nonwoven fabric is, for example, 50 volume% or more, may be 70 volume% or more, and may be 90 volume% or more.

### (iii) Solid Electrolyte Layer

The solid electrolyte layer may or may not contain a binder. Examples of the binder may include a rubber-based binder such as a butadiene rubber, a butadiene hydride rubber, a styrene butadiene rubber (SBR), a styrene butadiene hydride rubber, a nitrile butadiene rubber, a nitrile butadiene hydride rubber, and an ethylene propylene rubber; and a fluoride-based binder such as polyvinylidene fluoride (PVDF), a polyvinylidene fluoride -polyhexafluoropropylene copolymer (PVDF-HFP), polytetra fluoroethylene, and a fluorine rubber. The proportion of the binder in the solid electrolyte layer with respect to the 100 parts by weight of the solid electrolyte is, for example, 0 part by weight or more and 3 parts by weight or less.

The shape of the solid electrolyte layer in a plan view is preferably a rectangular shape including a longer side and a shorter side. The shape of the solid electrolyte layer in a plan view may be the same as the shape of the anode layer in a plan view, and may be the same as the shape of the cathode layer in a plan view. The Young’s modulus of the solid electrolyte layer is, for example 1 GPa or more. The thickness of the solid electrolyte layer is not particularly limited, and for example, it is 1 µm or more, may be 5 µm or more, and may be 10 µm or more. Meanwhile, the thickness of the solid electrolyte layer is, for example, 150 µm or less, and may be 100 µm or less.

The nonwoven fabric in the solid electrolyte layer may directly contact the cathode layer. Meanwhile, a cathode side solid electrolyte part may be arranged between the nonwoven fabric and the cathode layer. Arrangement of the cathode side solid electrolyte part may reduce internal resistance. The cathode side solid electrolyte part contains at least a solid electrolyte, and may contain a binder as required. The solid electrolyte and the binder are in the same contents as described above. The cathode side solid electrolyte part usually does not have electron conductivity.

The nonwoven fabric in the solid electrolyte layer may directly contact the anode layer. Meanwhile, an anode side solid electrolyte part may be arranged between the nonwoven fabric and the anode layer. Arrangement of the anode side solid electrolyte part may reduce internal resistance. The anode side solid electrolyte part contains at least a solid electrolyte, and may contain a binder as required. The solid electrolyte and the binder are in the same contents as described above. The anode side solid electrolyte part usually does not have electron conductivity.

### Cathode Layer

The cathode layer is a layer containing at least a cathode active material, and may contain at least one of a solid electrolyte, a conductive material and a binder, as required. Examples of the cathode active material may include an oxide active material. Examples of the oxide active material may include a rock salt bed type active material such as LiCoO₂, LiMnO₂, LiNiO₂, LiVO₂, and LiNi_{1/3}Co_{1/3}Mn_{1/3}O₂; a spinel type active material such as LiMn₃O₄, Li₄Ti₅O₁₂ and Li (Ni_{0.5}Mn_{1.5}) O₄; and an olivine type active material such as LiFePO₄, LiMnPO₄, LiNiPO₄, and LiCoPO₄.

A protective layer containing Li-ion conductive oxide may be formed on the surface of the oxide active material. The reason therefor is to inhibit the reaction of the oxide active material and the solid electrolyte. Examples of the Li-ion conductive oxide may include LiNbO₃. The thickness of the protective layer is, for example, 1 nm or more and 30 nm or less. Also, as the cathode active material, for example, Li₂S can be used.

Examples of the shape of the cathode active material may include a granular shape. The average particle size (D₅₀) of the cathode active material is not particularly limited, and for example, it is 10 nm or more, and may be 100 nm or more. Meanwhile, the average particle size (D₅₀) of the cathode active material is, for example, 50 µm or less, and may be 20 µm or less.

The cathode layer may contain a conductive material. Examples of the conductive material may include a carbon material, a metal particle, and a conductive polymer. Examples of the carbon material may include a particulate carbon material such as acetylene black (AB) and Ketjen black (KB), and a fiber carbon material such as carbon fiber, carbon nanotube (CNT), and carbon nanofiber (CNF). Also, the solid electrolyte and the binder to be used in the cathode layer are in the same contents as those described in “(1) Solid electrolyte layer” above; thus, the descriptions herein are omitted. The thickness of the cathode layer is, for example, 0.1 µm or more and 1000 µm or less. The shape of the cathode layer in a plan view is preferably a rectangular shape including a longer side and shorter side.

### Anode Layer

The anode layer is a layer containing at least an anode active material, and may contain at least one of a solid electrolyte, a conductive material and a binder, as required. Examples of the anode active material may include a Li-based active material such as a metal lithium and a lithium alloy; a carbon-based active material such as graphite, hard carbon and soft carbon; an oxide-based active material such as lithium titanate; and a Si-based active material such as a simple substance of Si, a Si alloy and a silicon oxide.

Examples of the shape of the anode active material may include a granular shape. The average particle size (D₅₀) of the anode active material is, for example, 10 nm or more, and may be 100 nm or more. Meanwhile, the average particle size (D₅₀) of the anode active material is, for example, 50 µm or less, and may be 20 µm or less.

The conductive material, the solid electrolyte and the binder to be used in the anode layer are in the same contents as those described in “(1) Solid electrolyte layer” and “(2) Cathode layer” above; thus, the descriptions herein are omitted. The thickness of the anode layer is, for example, 0.1 µm or more and 1000 µm or less. The shape of the anode layer in a plan view is preferably a rectangular shape including a longer side and a shorter side.

### Electrode Structure Body

The electrode structure body includes a cathode layer, a solid electrolyte layer and an anode layer. Here, when a set of the cathode layer, the solid electrolyte layer and the anode layer is regarded as a power generating unit, the electrode structure body may include just one of the power generating unit, and may include two or more thereof. When the electrode structure body includes two or more of the power generating unit, they may be connected in series and may be connected in parallel.

The electrode structure body may include a cathode current collector for collecting currents of the cathode layer. The cathode current collector is typically arranged in the position opposite to the solid electrolyte layer on the basis of the cathode layer. Examples of the material for the cathode current collector may include stainless steel, aluminum, nickel, iron, titanium and carbon. Also, examples of the shape of the cathode current collector may include a foil shape and a mesh shape.

The electrode structure body may include an anode current collector for collecting currents of the anode layer. The anode current collector is typically arranged in the position opposite to the solid electrolyte layer on the basis of the anode layer. Examples of the material for the anode current collector may include stainless steel, copper, nickel, and carbon. Also, examples of the shape of the anode current collector may include a foil shape and a mesh shape.

### 2. All Solid State Battery

The all solid state battery in the present disclosure may include an outer package for storing at least the electrode structure body. Examples of the outer package may include a laminate type outer package and a case type outer package.

The all solid state battery may include a restraining part that applies a restraining pressure to a thickness direction of the electrode structure body. The restraining pressure is, for example, 0.1 MPa or more, may be 1 MPa or more, and may be 5 MPa or more. Meanwhile, the restraining pressure is, for example, 100 MPa or less, may be 50 MPa or less, and may be 20 MPa or less.

The all solid state battery in the present disclosure is typically an all solid lithium ion secondary battery. The application of the all solid state battery is not particularly limited, and examples thereof may include a power source for vehicles such as hybrid electric vehicles (HEV), plug-in hybrid electric vehicles (PHEV), battery electric vehicles (BEV), gasoline-fueled automobiles and diesel powered automobiles. In particular, it is preferably used as a power source for driving hybrid electric vehicles, plug-in hybrid electric vehicles, or battery electric vehicles. Also, the all solid state battery in the present disclosure may be used as a power source for moving bodies other than vehicles (such as rail road transportation, vessel and airplane), and may be used as a power source for electronic products such as information processing equipment.

The present disclosure is not limited to the embodiments. The embodiments are exemplification, and any other variations are intended to be included in the technical scope of the present disclosure if they have substantially the same constitution as the technical idea described in the claims of the present disclosure and have similar operation and effect thereto.

### EXAMPLES

### Example 1

### Production of Cathode

As a cathode active material, LiNi_{1/3}Co_{1/3}Mn_{1/3}O₂ powder having an average particle size (D₅₀) measured based on a laser diffraction scattering method being 5 µm was used. Next, the surface of the cathode active material was coated with LiNbO₃ by a sol gel method. Also, as a sulfide solid electrolyte, 15LiBr-10LiI-75(0.75Li₂S-0.25P₂S₅) glass ceramic having an average particle size (D₅₀) measured based on a laser diffraction scattering method being 2.5 µm was used.

After that, the cathode active material and the sulfide solid electrolyte were weighted so as to be the cathode active material : the sulfide solid electrolyte = 75 : 25 in the weight ratio, and then they were mixed to obtain a first mixture. Next, with respect to 100 parts by weight of the cathode active material, weighed were 3 parts by weight of a SBR (styrene butadiene rubber) based binder and 10 parts by weight of a conductive material (carbon nano fiber, CNF) so as to be added to the first mixture to obtain a second mixture. Next, a dispersion medium (butyl butyrate) was added to the second mixture, the solid concentration was adjusted to 60 weight%, and subjected to an ultrasonic dispersion treatment for 1 minute to obtain cathode slurry.

The obtained cathode slurry was uniformly pasted on a cathode current collector (an aluminum foil having a thickness of 15 µm) in a weight amount of 15 mg/cm² by blade coating, and the product was dried at 100° C. for 60 minutes. Thereby, a cathode (cathode structure body) including a cathode current collector and a cathode layer was obtained.

### Production of Anode

As an anode active material, Si powder having an average particle size (D₅₀) measured based on a laser diffraction scattering method being 5 µm was used. Also, as a sulfide solid electrolyte, 15LiBr·10LiI·75(0.75Li₂S·0.25P₂S₅) glass ceramic having an average particle size (D₅₀) measured based on a laser diffraction scattering method being 2.5 µm was used.

After that, the anode active material and the sulfide solid electrolyte were weighed so as to be the anode active material : the sulfide solid electrolyte = 50 : 50 in the weight ratio, and they were mixed to obtain a third mixture. Next, with respect to 100 parts by weight of the anode active material, weighed were 3 parts by weight of the SBR-based binder and 10 parts by weight of a conductive material (CNF), so as to be added to the third mixture to obtain a fourth mixture. Next, a dispersion medium (butyl butyrate) was added to the fourth mixture, the solid concentration was adjusted to 40 weight%, and subjected to an ultrasonic dispersion treatment for 1 minute to obtain anode slurry.

The obtained anode slurry was uniformly pasted on an anode current collector (roughen copper foil having a thickness of 25 µm, Rz = 5 µm) in a weight amount of 3 mg/cm² by blade coating, and the product was dried at 100° C. for 60 minutes. Thereby, an anode (anode structure body) including an anode current collector and an anode layer was obtained.

### Production of Solid Electrolyte Layer

As a sulfide solid electrolyte, 15LiBr·10LiI·75(0.75Li₂S·0.25P₂S₅) glass ceramic having an average particle size (D₅₀) measured based on a laser diffraction scattering method being 2.5 µm was used. Also, as a binder, a SBR-based binder was used.

After that, the sulfide solid electrolyte and the binder are weighed so as to be the sulfide solid electrolyte : the binder = 99 : 1 in the weight ratio, and they were mixed to obtain a fifth mixture. Next, a dispersion medium (butyl butyrate) was added to the fifth mixture, the solid concentration was adjusted to 50 weight%, and subjected to an ultrasonic dispersion treatment for 1 minute to obtain slurry for a solid electrolyte layer.

After that, on an aluminum foil, a nonwoven fabric made of polyester (thickness: 15 µm, void rate: 80%, tensile strength of MD: 5 N/cm, tensile strength of CD: 1 N/cm) was arranged. Next, the obtained slurry was uniformly pasted on the nonwoven fabric made of polyester in a weight amount of 5.8 mg/cm² (thickness including the nonwoven fabric: 15 µm) by blade coating, and the product was dried at 100° C. for 60 minutes. Thereby, a transfer part including the aluminum foil and the solid electrolyte layer was obtained.

### Production of All Solid State Battery

The transfer part was cut out into the rectangular shape having 7.5 cm by 5.1 cm. On this occasion, the transfer part was cut out so that the fiber direction (MD) thereof became parallel to the longer side of the rectangular. Also, the anode structure body was cut out into the rectangular shape having 7.5 cm by 5.1 cm. Also, the cathode structure body was cut out into the rectangular shape having 7.3 cm by 4.9 cm.

After that, the anode layer in the anode structure body and the solid electrolyte layer in the transfer part were overlapped, roll-pressed at the pressing pressure of 1 ton/cm². On this occasion, roll-pressing was conducted so that the fiber direction (MD) in the solid electrolyte layer became parallel to the running direction of the roll-pressing. Next, the aluminum foil was peeled off from the transfer part. Thereby structure body X including the anode current collector, the anode layer, and a solid electrolyte layer, was obtained. Next, the solid electrolyte layer in the structure body X and the cathode layer in the cathode structure body were overlapped, and roll-pressed at the pressing pressure of 3 ton/cm². On this occasion, roll-pressing was conducted so that the fiber direction (MD) in the solid electrolyte layer became parallel to the running direction of the roll-pressing. Thereby a structure body Y including the anode current collector, the anode layer, the solid electrolyte layer, the cathode layer and the cathode current collector, was obtained. Incidentally, the area of the facing part in the structure body Y was 36.0 cm². Next, the structure body Y was sealed by an outer package (laminate film made of aluminum) in which a cathode terminal and an anode terminal were attached in advance, and thereby an all solid state battery was obtained.

### Example 2

An all solid state battery was obtained in the same manner as in Example 1, except that the transfer part and the anode structure body were respectively cut out into the rectangular shape having 8.6 cm by 4.5 cm, and the cathode structure body was cut out into the rectangular shape having 8.4 cm by 4.3 cm.

### Example 3

An all solid state battery was obtained in the same manner as in Example 1, except that the transfer part and the anode structure body were respectively cut out into the rectangular shape having 9.7 cm by 4.0 cm, and the cathode structure body was cut out into the rectangular shape having 9.5 cm by 3.8 cm.

### Example 4

An all solid state battery was obtained in the same manner as in Example 1, except that the transfer part and the anode structure body were respectively cut out into the rectangular shape having 10.7 cm by 3.6 cm, and the cathode structure body was cut out into the rectangular shape having 10.5 cm by 3.4 cm.

### Example 5

An all solid state battery was obtained in the same manner as in Example 1, except that the transfer part and the anode structure body were respectively cut out into the rectangular shape having 12.2 cm by 3.2 cm, and the cathode structure body was cut out into the rectangular shape having 12.0 cm by 3.0 cm.

### Comparative Example 1

An all solid state battery was obtained in the same manner as in Example 5 except that the transfer part was cut out so that the fiber direction (MD) became parallel to the shorter side of the rectangular.

### Comparative Example 2

An all solid state battery was obtained in the same manner as in Example 1, except that the transfer part and the anode structure body were respectively cut out into the foursquare shape having 6.2 cm by 6.2 cm, and the cathode structure body was cut out into the foursquare shape having 6.0 cm by 6.0 cm.

### Evaluation

A cycle test was conducted using all solid state batteries produced in Examples 1 to 5 and Comparative Examples 1, 2. The measurement was conducted in the following procedures. First, the all solid state battery was respectively restrained at the pressure of 100 MPa, and CCCV-charged at the current rate of 36 mA until 4.5 V (current cut value: 0.36 mA). Next, the battery was respectively CCCV-discharged at the current rate of 36 mA until 3.0 V (current cut value: 0.36 mA). The charge and discharge were performed for 100 cycles to obtain capacity durability. The results are shown in Table 1.

Capacity durability (%) = Discharge capacity of 100th cycle / discharge capacity of 1st cycle * 100

TABLE 1

| | Size of facing part | | | Area of facing part (cm²) | Arrangement of electrode and nonwoven fabric | Capacity durability (%) |
|---|---|---|---|---|---|---|
| | Longer Az (cm) | Shorter B (cm) | A/B | | | |
| Example 1 | 7.3 | 4.9 | 1.5 | 36.0 | Longer side of electrode and nonwoven fabric MD: parallel | 56.8 |
| Example 2 | 8.4 | 4.3 | 2.0 | 36.0 | Longer side of electrode and nonwoven fabric MD: parallel | 59.8 |
| Example 3 | 9.5 | 3.8 | 2.5 | 36.0 | Longer side of electrode and nonwoven fabric MD: parallel | 61.5 |
| Example 4 | 10.5 | 3.4 | 3.1 | 36.0 | Longer side of electrode and nonwoven fabric MD: parallel | 61.1 |
| Example 5 | 12.0 | 3.0 | 4.0 | 36.0 | Longer side of electrode and nonwoven fabric MD: parallel | 59.1 |
| Comp. Ex. 1 | 12.0 | 3.0 | 4.0 | 36.0 | Shorter side of electrode and nonwoven fabric MD: parallel | 49.7 |
| Comp. Ex. 2 | 6.0 | 6.0 | 1.0 | 36.0 | - | 53.9 |

As shown in Table 1, capacity durability of Examples 1 to 5 was respectively higher than that of Comparative Examples 1 and 2. The reason therefor is presumably because the anisotropy of the tensile strength was moderated by setting the angle formed by the longer direction in the facing part and the fabric direction in the nonwoven fabric to be small.

### Reference Signs List

1 cathode layer
2 anode layer
3 solid electrolyte layer
4 cathode current collector
5 anode current collector
10 electrode structure body
100 all solid state battery

What is claimed is:

1. An all solid state battery comprising an electrode structure body including a cathode layer, an anode layer, and a solid electrolyte layer arranged between the cathode layer and the anode layer, wherein:
the electrode structure body includes a facing part where the cathode layer and the anode layer face to each other;
in a plan view along a thickness direction, a shape of the facing part is a rectangular shape including a longer side and a shorter side;
a rate of a length of the longer side with respect to a length of the shorter side is 1.5 or more;
the solid electrolyte layer contains a nonwoven fabric, and a solid electrolyte arranged inside the nonwoven fabric; and
in the plan view, an angle formed by a longer direction in the facing part and a fabric direction in the nonwoven fabric is 0° or more and 30° or less.

2. The all solid state battery according to claim 1, wherein the angle is 0° or more and 10° or less.

3. The all solid state battery according to claim 1, wherein a void rate in the nonwoven fabric is 70% or more and 90% or less.

4. The all solid state battery according to claim 1, wherein, in the nonwoven fabric, a tensile strength of the fabric direction is larger than a tensile strength of a direction orthogonal to the fabric direction.

5. The all solid state battery according to claim 1, wherein the solid electrolyte is an inorganic solid electrolyte.

6. The all solid state battery according to claim 5, wherein the inorganic solid electrolyte is at least one kind of a sulfide solid electrolyte, an oxide solid electrolyte, and a hydride solid electrolyte.

7. The all solid state battery according to claim 1, wherein the solid electrolyte is a molten salt, which is in a solid state at 25° C.

8. The all solid state battery according to claim 1, wherein the solid electrolyte is a plastic crystal solid electrolyte.
